(19) United States
(12) Patent Application Publication
(10) Pub. No.: US 2007/0143482 A1
(43) Pub. Date: Jun. 21, 2007

(54) System and method for handling multiple user preferences in a domain

(76) Inventor: William F. Zancho, Hawthorn Woods, IL (US)

Correspondence Address: MOTOROLA, INC., 1303 EAST ALGONQUIN ROAD, IL01/3RD, SCHAUMBURG, IL, 60196, US

(21) Appl. No.: 11/312,022

(22) Filed: Dec. 20, 2005

(51) Int. Cl. G06F 15/16

(52) U.S. Cl. 709/227

(57) ABSTRACT

A preference-handling system includes one or more communication interfaces, user interfaces, memory, and a controller. The controller can be used in a vehicle to handle preferences. The communication interfaces communicatively connect with devices in a domain, and the memory stores preferences for users. The controller is operably coupled to the communication interfaces, the memory, and a domain system. The controller is configured to monitor for devices active in the domain of the unit and determine a preference for each of at least two users associated with active devices. Each of the preferences is related to controlling behavioral operation of or content presented by the domain system, which can be an entertainment, user interface, navigation, communication, or environmental system in the vehicle. The controller arbitrates the preferences based on an arbitration scheme of the controller and controls operation of the system based on the arbitration of the preferences.

### FIELD OF THE DISCLOSURE

The subject matter of the present disclosure generally relates to a system and method for handling multiple preferences of users and more particularly relates to a system and method for handling preferences of multiple users in a domain of a network.

### BACKGROUND OF THE DISCLOSURE

A particular user may have preferences that they prefer when using and interacting with various devices or systems. For examples, users may prefer various forms of information and may prefer a certain way that information is delivered to them on a particular type of device or in a given situation. Preferences for a particular user can generally include visual attributes (e.g., fonts, contrast, brightness, background pattern, color, icon type, icon location, choice of digital or analog gauges), environmental attributes (e.g., temperature, humidity levels, car seat position, vehicle mirror orientation), audio attributes (e.g., sound levels, equalization levels), and a host of other preferences.

Typically, users must program a device with their preferences. Consequently, each time a user encounters a new device, she must program her preferences into the device or simply use the preprogrammed forms of user interaction established in the device by default. As a solution to this problem, U.S. Pat. Nos. 5,633,484 and 5,814,798, which are incorporated herein by reference in their entireties, disclose techniques for establishing and managing preferences for a user. Using the disclosed techniques, a user can readily transport her preferences to various devices, such as telephones, automobiles, and computers, which she uses and encounters.

In a network, various devices and users can interact with one another in an environment. One type of network is a seamless mobility network that allows devices of various users to interact seamlessly in a plurality of environments or domains, such as a vehicle, a home, an office, etc. Typically, the users in the seamless mobility network have different preferences. When a group of users interacts together in a domain, conflicts may arise when there are conflicting preferences applicable to current circumstances in the domain. For example, two users in a vehicle may have different preferences for what volume and equalization levels should be used to deliver music in a vehicle. Thus, determining what volume and equalization levels to use in the vehicle presents a problem if both users attempt to apply their particular preferences to devices in the vehicle.

### BRIEF DESCRIPTION OF THE DRAWINGS

FIG. 1 illustrates an embodiment of a platform or seamless mobility network according to certain teachings of the present disclosure.

FIG. 2 illustrates an embodiment of a process for handling preferences in a domain.

FIG. 3 illustrates an embodiment of a preference selection matrix.

FIG. 4 illustrates an embodiment of a controller in a vehicle domain according to certain teachings of the present disclosure.

FIG. 5 illustrates an embodiment of the controller handling preferences for multiple users in a vehicle domain.

FIGS. 6A-6B illustrate embodiments of arbitration schemes in tabular form for arbitrating preferences for multiple users in a vehicle domain.

FIGS. 7A-7C illustrate embodiments of arbitration schemes in graphical form for arbitrating preferences for multiple users in a vehicle domain.

### DETAILED DESCRIPTION

Systems and methods for handling multiple preferences in a domain are disclosed. In one embodiment, a preference-handling method involves storing user preference accessible to a controller. For example, these preferences can be stored remotely on a network accessible to the controller, stored on individual portable devices, or stored locally at the controller. Preferences are determined for at least two users in the domain of the controller. For example, the controller can monitor for wireless devices active in a wireless personal area network of the controller and obtain the preferences of those users associated with the active devices from the device itself, from local memory of the controller, or from elsewhere. The determined preferences are related to controlling operation of a domain system in the domain of the controller. The domain system can be a networked computer system, a user interface, an entertainment system, an environmental system, or a communication system. The determined preferences are arbitrated based on an arbitration scheme of the controller, and operational behavior of the device or system is controlled based on the arbitration of the preferences.

In another embodiment, a preference-handling system includes one or more communication interfaces, memory, and a controller. The one or more communication interfaces can be used to connect communicatively with devices in a domain of the preference-handling system or with memory. The memory stores preferences for users. The memory can be stored on a portable device active in the domain, can be stored remotely at a network accessible storage system, or can be stored locally at the controller. The controller is operably coupled to the communication interfaces, the memory, and a domain system, such as previously described. The controller is configured to determine preferences for at least two users active in the domain. For example, the controller can monitor for wireless devices active in a wireless personal area network of the controller and can upload preferences from the devices or can access preferences already stored in the controller's memory. The determined preferences are related to controlling operation of the domain system operably coupled to the controller. The controller arbitrates the preferences based on an arbitration scheme and controls operation of the domain system based on the arbitration of the preferences.

The arbitration scheme can involve selecting a type in all or most of a list of preferences, selecting a preference having a highest priority, selecting a value within ranges of each of the preferences, selecting a preference having a greatest weighting, or selecting a preference based on a task controlling the domain. In addition, the arbitration scheme can involve assigning preferences to one of a plurality of categories. The categories can include non-compromiseable preferences, compromiseable preferences, and yielding preferences.

The foregoing is not intended to summarize each potential embodiment or every aspect of the present disclosure. Let us now refer to the figures to describe the subject matter of the present disclosure in more detail.

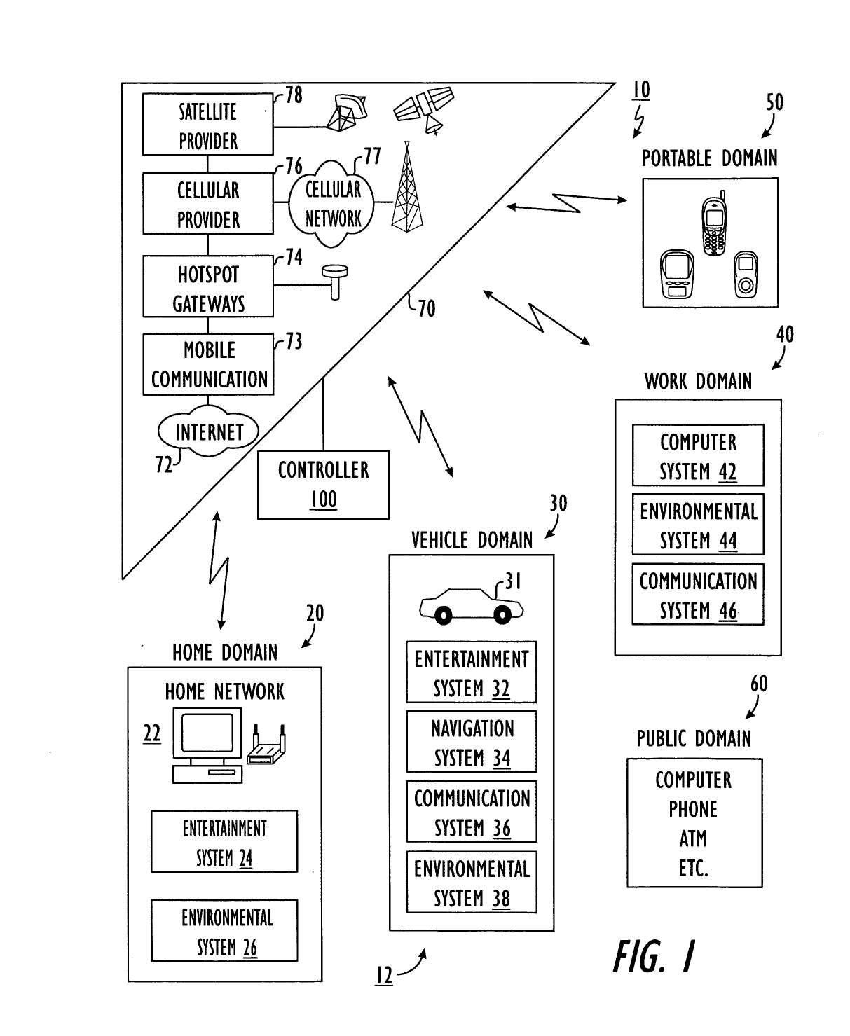

Referring to FIG. 1, an embodiment of a platform 10 according to certain teachings of the present disclosure is schematically illustrated. The present embodiment of the platform 10 illustrates a variety of possibilities available for the systems and methods of the present disclosure. In one embodiment, the platform 10 can be a seamless mobility network. However, the platform 10 in a broader sense allows disparate devices and users to interact with one another across various networks. In this broader sense, the platform 10 provides users with consistent behavior, user interaction, and preferences across disparate devices, applications, environments, and domains of networks. In this way, a user's experience can be substantially consistent with her mental model of interaction between various domains or environments, and her experience can be substantially the same, if her preferences so dictate, regardless of the various devices with which she interacts.

In the illustrated example, the platform 10 has a plurality of domains or environments 12, such as a home domain 20, a vehicle domain 30, a work domain 40, a portable domain 50, and a public domain 60. It will be appreciated that the platform 10 can have more or less domains 12. In addition, it will be appreciated that the platform 10 does not necessarily apply only to an individual user or device or a particular set of users or devices. Rather, the platform 10 can apply to any user or device that is compatible with the architectural framework, data structures, communication protocols, applications, etc. of the platform 10.

The domains 12 are defined by a set of circumstances, a set of users, a specific environment (e.g., vehicle, home, office, etc.), and a set of devices and systems capable of operating and interacting in the domains. For example, the home domain 20 can include a home networked computer system 22, an entertainment system 24, and an environmental system 26. The vehicle domain 30 for a vehicle 31 can include an entertainment system 32, a user interface or navigation system 34, a communication system 36, and an environmental system 38. The work domain 40 can include a networked computer system 42, a communication system 44, and an environmental system 46. The portable domain 50 can include various portable electronic devices, such as a Personal Digital Assistant (PDA), a portable music player, a portable video player, a portable navigation device, a cellular phone, a wireless headset, and a laptop. Finally, the public domain 60 can include computers, telephones, Automated Teller Machines, and other public devices and systems that a user may encounter and use in public.

The various devices and systems in these domains 12 are capable of interacting or communicating with other devices and systems in the same domain or in different domains using communication techniques known in the art. In one example, the devices and systems in the domains 12 are capable of wired or wireless communication with various communication sources 70, which can include the Internet 72, mobile communication 73 (e.g., Dedicated Short Range Communication (DSRC) and vehicle-to-roadside/vehicle-to-vehicle communication), hotspot gateways 74, cellular service providers 76 and networks 77, and satellite providers 78. Some examples of wireless communication include cellular communication, Bluetooth®, Wi-Fi, Ultra Wide Band (UWB), and other wireless communication techniques known in the art.

The platform 10 also includes a controller 100 capable of wired and wireless communication with the various devices and systems in the domains 12 and with the sources 70. In one embodiment, the controller 100 is a central server or a host computer system for arbitrating preferences between users in one or more of the various domains 12. In a distributed embodiment, one or more of the domains 12 can include a controller 100. For example, the networked computer system 22 in the home domain 20 can embody features of the controller 100 and can handle preferences in the home domain 20. In another example, the vehicle domain 30 can include such a controller 100 for arbitrating preferences between portable devices of the portable domain 50 interacting with the vehicle systems 32, 34, 36, and 38. In a further distributed embodiment, one or more of the devices or systems of the platform 10 can include features of the controller 100.

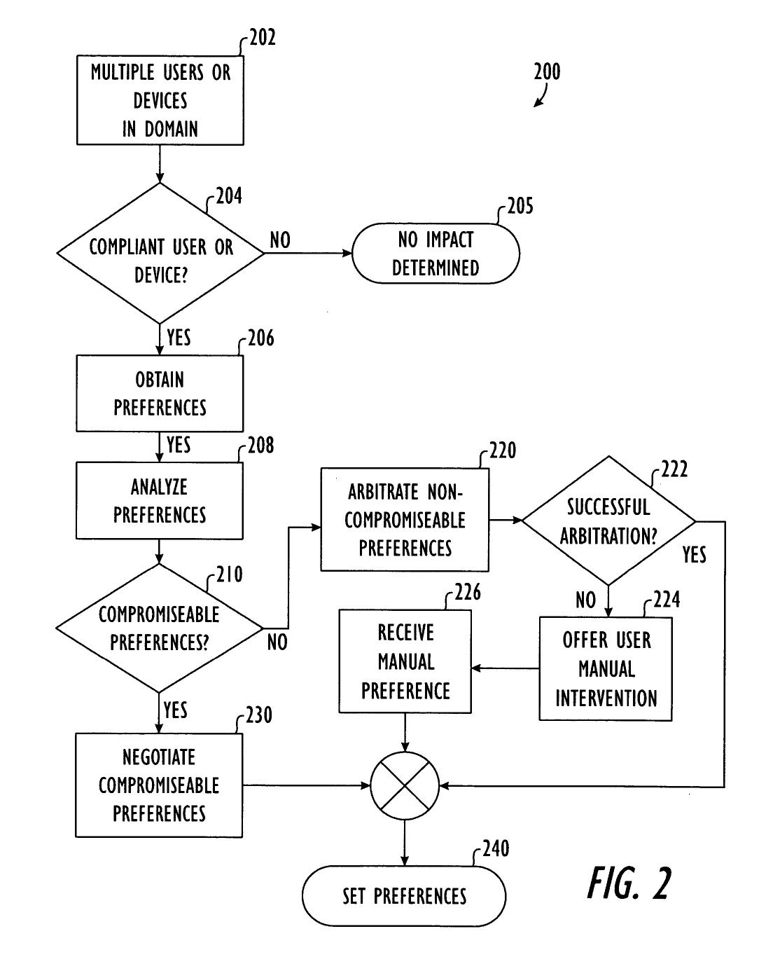

Now that the platform 10 has been described, the present discussion turns to an embodiment of a process 200 shown in FIG. 2 for handling preferences in a domain. In the preference handling process 200, two or more users and/or their devices enter or are currently active in a domain (Block 202). As disclosed herein, the controller can identify users by monitoring for active devices associated with users or by receiving manual input. Regardless of how this is done, a determination is made whether the user has preferences that are compliant with the preference handling process of the platform (Block 204). For example, a particular device associated with a user may be detected in the domain, but the device may not have the necessary information or preferences associated with it. If the user or her device is not compliant, then they will have no impact on any preference handling to be performed in the domain (Block 205).

For those compliant users or devices, the preferences associated with them are obtained (Block 208). Obtaining the preferences can involve one of a variety of methods. In one example, a compliant device active in the domain may store preferences for the user, and these preferences can be accessed or uploaded to the controller. In another example, a compliant device active in the domain may have an identification associated with it, such as a network or Internet Protocol (IP) address. This identification can then be used by the controller to obtain preferences associated with the user from a storage system or elsewhere using techniques known in the art. In a third example, the user can have a donor device with a memory for storing preferences, and the user can connect the donor device with an appropriate interface of the controller in the domain. Examples of a donor device used in a vehicle domain and elsewhere are disclosed in incorporated U.S. Pat. Nos. 5,633,484 and 5,814,798. In a fourth example, the user can access a user interface to manually input that they are present in the domain, and the preferences associated with the user can be obtained from a local memory in the domain or from a memory stored elsewhere on a network.

Once the relevant preferences have been obtained, an analysis of those preferences is made to determine how to handle the preferences from multiple users (Block 208). In this step, a determination is made as to who “owns” or controls the domain or a system in the domain. For example, a particular user may be designated as owner of the domain. The preferences associated with this user may always be applied, or this user's preferences are given more weight in determining how to handle conflicts between preferences. In addition, a determination is made as to what rank the various users have in the domain. For example, one user may be directly associated with a domain, such as a family member in a home domain. However, another user may have compliant preferences for this home domain, but they may be a friend or the like and may have a lower rank in the home domain compared to the family member's rank.

Furthermore, this step 208 involves determining which of the preferences associated with the users are applicable to the current circumstances in the domain. For example, the preferences associated with a user can encompass an entire variety of preferred user interactions, such as audio levels, visual effects, preferred media, and others detailed herein. Preferences associated with audio levels and settings would be applicable in the domain if the domain has an entertainment system. Therefore, in this situation, a determination would be made that audio-related preferences are applicable to current operation of the entertainment system in the domain.

Continuing with the process 200, step 210 determines what type or category the applicable preferences have. The preferences are classified according to a rigid or non-compromiseable category, a flexible or compromiseable category, or a yielding category. A preference in the non-compromiseable category does not allow for compromise and acts as a veto to other preferences or alternatives with which it comes in conflict. A preference in the compromiseable category does allow for compromise and has a range, weight, or priority that can be used to negotiate or compromise with other preferences or alternatives with which it comes in conflict. A preference in the yielding category automatically yields to any other preference with which it comes in conflict.

Although preferences can be defined as rigid or non-compromiseable, a policy or rule relevant to the domain can be associated with a non-compromiseable preference. The policy or rule can account for situations, such as those dealing with emergencies, safety, or health, where other preferences or the default operation of a system or device needs to take precedence over any non-compromiseable preferences that a user may have. For example, a driver may have a non-compromiseable preference indicating that communication devices of passengers cannot use handsfree or other communication capabilities of the vehicle. In an emergency (i.e., after air bag deployment), however, such a non-compromiseable preference may be overridden by a policy or rule so that a passenger can take advantage of the communication capabilities of the vehicle. In addition to selecting a preference based on policies and rules, a preference can be selected based on a restriction, such as a health restriction, relevant to a domain, a user, or a system in the domain.

Preferences that are non-compromiseable are arbitrated or negotiated according to one or more of the arbitration schemes disclosed herein (Block 220). In general, these arbitration schemes are guided by the weightings or rankings associated with the preferences. In particular, preferences associated with the owner of the domain are first selected if the owner of the domain is present (e.g., a device associated with the owner is active or detected in the domain). Next, common preferences associated with all users in the domain are selected. Otherwise, those remaining preferences associated with the user having the highest ranking are selected.

After arbitration of the non-compromiseable preferences, a determination is made whether the arbitration scheme was successful in arbitrating a result (Block 222). If the arbitration was successful, the process 200 continues and sets those arbitrated preferences at step 240. Depending on the circumstances, however, there may be situations where a successful result does not occur during arbitration. For example, a particular arbitration scheme may not be capable of resolving a particular conflict between non-compromising preferences of two or more users, or historical arbitration information stored in memory may have not offered a solution to the conflicts. Therefore, an offer is made to the owner of the domain, a high ranked user, or other user to intervene manually in the arbitration process (Block 224). In this situation, the user is allowed to input a selection of a preference manually (Block 226). The manual selection can then be stored for arbitrating preferences in the future in similar circumstances. After the manual selection is received, the process 200 continues and sets the preference at step 240.

Preferences that are compromiseable are also arbitrated or negotiated according to one or more of the arbitration schemes disclosed herein (Block 230). In general, these arbitration schemes involve algorithms that average, weight, or prioritize the preferences. In addition, these schemes can use the order in which the users or devices entered the domain as criteria for selecting preferences. Furthermore, the arbitration schemes can use a history of selected preferences for a given set of users to determine how to handle preferences for the same users in the same situation. For example, results of arbitrating or negotiating preferences between a particular group of users can be accessed and can be used to set shared preferences in a similar situation.

Once selections have been made in steps 220 and 230, the shared or selected preferences are set so that operation of systems in the domain can use these set preferences (Block 240). Moreover, it is beneficial to store these selections so that they can be accessed later to provide a history for arbitrating or negotiating preferences again for this group of users in this domain.

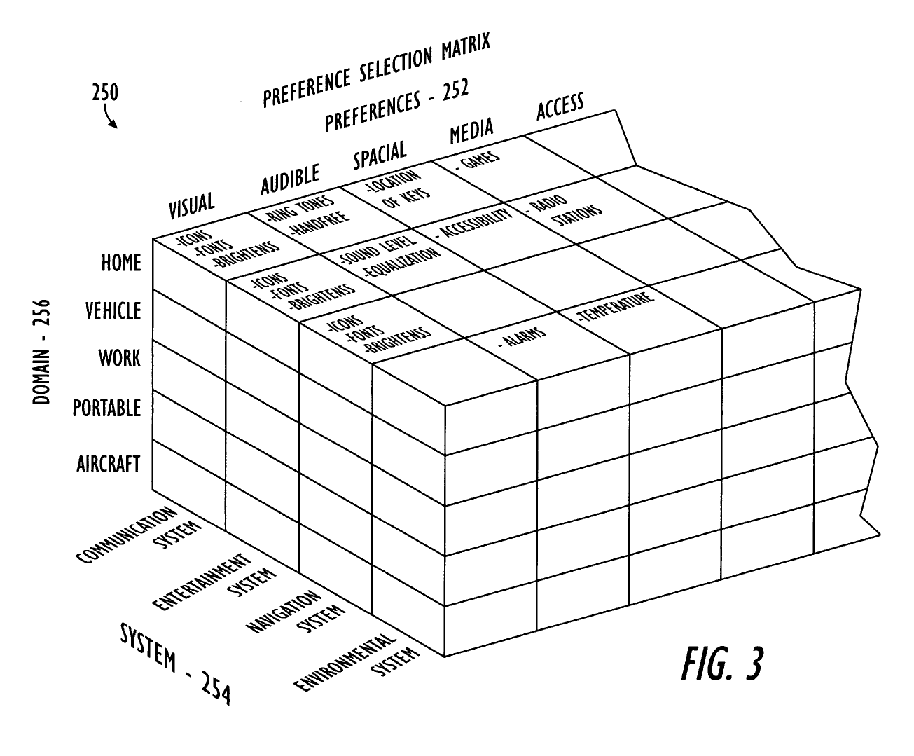

As alluded to previously, various types of preferences can be handled according to the techniques of the present disclosure. Referring to FIG. 3, an embodiment of a preference selection matrix 250 is shown. This matrix 250 is similar to that disclosed in incorporated U.S. Pat. No. 5,814,798 and can be used to provide the benefits of intelligent user interface to users. This matrix 250 graphically represents how a user's preferences can be stored in one or more devices, memory, or elsewhere on a network.

As graphically shown, the user's preference can be viewed as a multi-dimensional matrix 250 having a preference category axis 252, a system or device axis 254, and an environment or domain axis 256. The preference category axis 252 is classified by various types or categories of preferences and user interaction modalities, such as visual, audible, spatial, media, haptic, etc. The system or device axis 254 defines particular categories of systems and devices, such as communication systems (e.g., cellular telephones, headsets, handsfree units), entertainment systems (e.g., radios, video players, TVs), navigation systems (e.g., vehicle navigation unit), and environmental systems (e.g., heater, air conditioner). It is understood that these categories can be further defined and particularized to specific types of devices and system or even particularly identified devices and systems. The environment or domain axis 256 defines categories of various domains or environments where the user's preferences are applicable in a seamless mobility network or more general network platform. For example, the domains 256 include home, vehicle, work, portable, and aircraft, but the matrix can include more or less categories and can include specific locations.

Particular user preferences are stored in attribute cells located at the intersection of the matrix's different axes 252, 254, and 256. Using the matrix 250, the controller, devices, and systems of the present disclosure can use techniques disclosed in the incorporated U.S. Pat. No. 5,814,798 to predict a users preferences based on a “context” of a particular situation. The “context” is determined by the intersection of axes 252, 254, and 256 as they relate to which domain the user is in (axis 256), what devices or systems are operating in the domain (axis 254), and what actions or types of user interaction are being used in the domain (axis 252). Although not shown in FIG. 3, the matrix 250 also includes information on whether preferences are compromiseable, non-compromiseable, or yielding, as discussed previously.

For the sake of illustration, several preferences in the attribute cells of the matrix 250 are discussed. In general, preferences associated with the visual category of axis 252 can include font types, font sizes, menu order preferences, menu size preferences, window size preferences, locations of icons, patterns, colors, font sizes, and preference for analog or digital gauges or display graphs. Preferences for the audible category of axis 252 can include types of prompts such as key feedback prompts, e-mail audible feedback prompts, bad move error prompts or change done prompts, negative indication preferences, speech and language recognition preferences, ringing such as urgent ringing, normal ringing, data ringing, volume preferences, tone type preferences, or commercial broadcast station selection preferences, base and treble control as well as fade and balance preferences. Preferences associated with the spatial category of axis 252 can include temperature preferences, humidity preferences, percentage of outside (fresh) air preferences, air conditioning balance preferences, car seat position preferences, automobile mirror position preferences, and seat heater temperature preferences.

For example, various categories (axis 252) for systems (axis 254) in the home domain (axis 256) can include preferences related to room-to-room distribution of access to networks, network media access (e.g., ability of family members and/or guests to access subscription based media services in the home domain), sources of entertainment, room-to-room distribution of entertainment, color settings, preferences to skip TV commercials, audio preferences, preset radio stations, ambiance settings, volume levels, air-conditioning, heating, humidity, and lighting.

For example, various categories (axis 252) for systems (axis 254) in the vehicle domain (axis 256) can include preferences related to audio preferences (e.g., equalization levels, volume levels), preferred media (e.g., genre, songs, preset radio stations, etc.), navigation routes, hands-free cellular phone capabilities (e.g., ability of passengers to have calls routed through vehicle's audio system), access network media (e.g., ability of passengers to access subscription based media services in the vehicle), seat and mirror positions, and air-conditioning settings.

For example, various categories (axis 252) for systems (axis 254) in the work domain (axis 256) can include preferences related to teams or shifts of employers, shared office equipment (e.g., copiers and computer work stations), and office space or conference rooms (e.g., lighting, air conditioning, heating, projector control, video-conferencing operation, and ring control). For the portable domain (axis 256), preferences can be related to preferences for handling calls, volume settings, preferred types of media (e.g., music or video), etc.

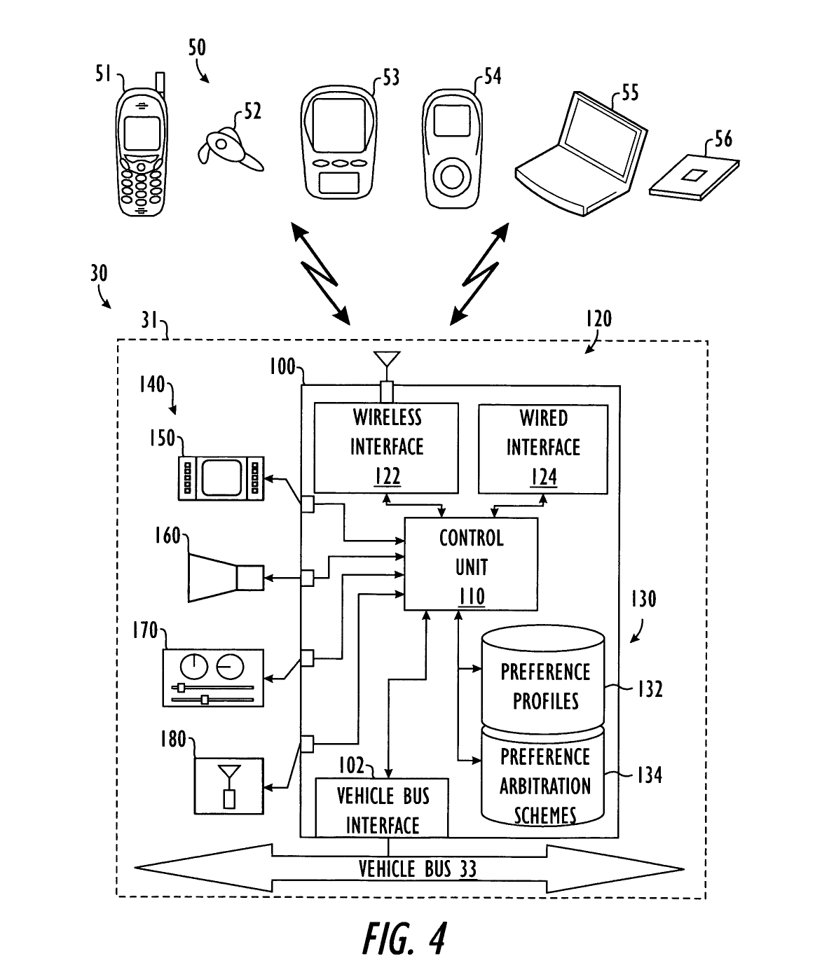

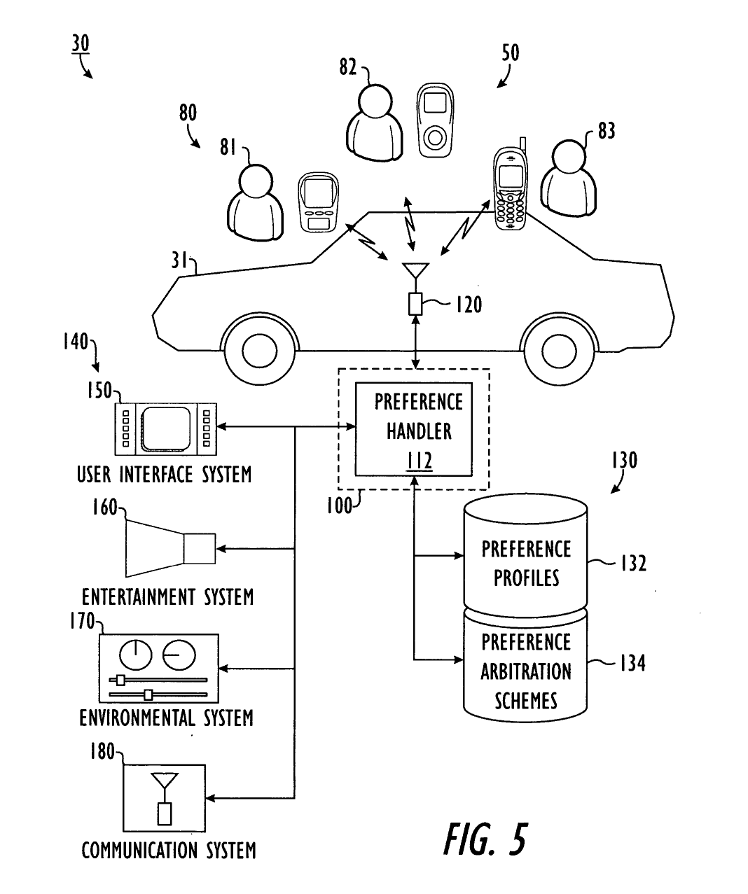

With an understanding of the process for handling various preferences discussed above with reference to FIG. 2 and the examples of preferences discussed above with reference to FIG. 3, we now turn to FIGS. 4 and 5 to discuss some detailed examples of handling preferences in a vehicle domain 30. Although the discussion that follows focuses on the vehicle domain 30 and those preferences, devices, and systems associated with a vehicle 31, it will be appreciated with the benefit of the present disclosure that the same teachings disclosed herein can be applied to other domains in the platform 10 of FIG. 1.

In FIG. 4, the controller 100 is shown in more detail in the vehicle domain 30 of a vehicle 31. In general, the vehicle domain 30 can be part of a platform discussed previously, and the controller 100 can be part of a server or other computer system located somewhere else in the platform. In the present example, however, the controller 100 is integrated into the vehicle 31. The controller 100 has a control unit 110, interfaces 120, and memory 130. A vehicle bus interface 102 connects the controller 100 to an existing vehicle bus 33 using techniques known in the art, such as an On-Board-Diagnostic II (OBD-II) connection or other bus interface. The vehicle bus interface 102 provides the controller 100 with access to features and components of the vehicle 31, such as power, ground, ignition, mute, mileage, speed, controls, parameters, and other vehicle information.

The controller 100 is communicatively connected to one or more vehicle systems 140, such as a user interface or navigation system 150, an entertainment system 160, an environmental system 170, and a communication system 180 in the vehicle 31. In general, the controller 100 is communicatively connected to the systems 140 using input/output interfaces known in the art or using the vehicle bus interface 102 and vehicle bus 33.

The user interface system 150 can include various controls for other components of the vehicle 31 and can include a navigation system. The entertainment system 160 can include a radio, a video display, a DVD player, etc. The environmental system 170 can include an air conditioning system, a heater system, power seat controls, seat warmers, etc. The communication system 180 can include a cellular interface, a Global Positioning System interface, an in-vehicle microphone, an in-vehicle speaker, a Telematics system, and a Bluetooth®-enabled unit capable of Handsfree.

In the present example, the interfaces 120 of the controller 100 establish a personal area network (PAN) that defines the extent of the domain 30 in the vehicle 31. Within the personal area network, multiple personal devices 50 can interact simultaneously with the controller 100. In the present example, the devices 50 include, but are not limited to, a cellular phone 51, a wireless headset 52, a PDA 53, a portable music player 54, a laptop computer 55, a dedicated donor device 56, portable navigation device (not shown), and a portable video player (not shown). The dedicated donor device 56 can be similar to the donor device disclosed in the incorporated U.S. Pat. Nos. 5,633,484 and 5,814,798 and can be a portable memory card or a widely accessible central database that stores preferences for users.

The devices 50 and the controller 100 are associated with the same platform, such as previously discussed, so that all of the devices 50 and controller 100 are compliant with techniques disclosed herein for arbitrating conflicting preferences. To be compliant, the various devices 50, controller 100, interfaces 120, memory 130, and other necessary components must support the common platform's memory storage, architectural framework, data structures, communication protocols, software, etc., as will be apparent to one skilled in the art.

The devices 50 can interact with the controller 100 using wired or wireless interfaces 122 and 124 known in the art. One or more of the devices 50 can contain a dedicated memory for storing preferences associated with the users of the device 50. Preferably, the preferences stored in the device 50 are comprehensive and encompass the various forms of interaction detailed herein. Alternatively, one or more of the devices 50 may not contain a dedicated memory for storing preferences. Instead, such devices 50 may be associated with a particular user by an identification number, such as a network or IP address. The preferences associated with the user of such a device 50 may be stored elsewhere outside the vehicle domain 30 or stored locally in memory 130 of the controller 100. When the particular device 50 and associated user are identified, the controller 100 can access those preferences.

The controller 100 has preference profiles 132 for storing user preferences and preference arbitration schemes 134 for handling preferences of multiple users. The preference profiles 132 and preferences arbitration schemes 134 can be entered and stored in memory 130 using direct entry with the user interface 150, uploads from the devices 50, or other techniques known in the art.

With an understanding of the controller 100 in the vehicle domain 30 of FIG. 4, we now turn to FIG. 5 to discuss examples of multiple users interacting with the controller 100 in the vehicle domain 30. In FIG. 5, the controller 100 is illustrated relative to some users 80 having portable devices 50 brought into a vehicle 31. The controller 100 includes a preference handler 112 for determining how to arbitrate or negotiate between various preferences of the users 80. The preference handler 112 is schematically shown as a component of the controller 100 but is preferably embodied in software.

During operation, the preference handler 112 determines the “context” of the domain 30. The context is defined by what users 80 are active, what systems 140 are operating, what operations are requested, and what preferences are associated with the users 80 in the domain 30. Based on the context, the preference handler 112 uses a preference arbitration scheme 134 to decide how to handle preferences when they conflict.

As noted previously, determining which users 80 are in the domain 30 can involve monitoring for devices 50 of the users 80 active in the domain 30 and obtaining the preferences associated with those users 80 from the device 50, from local memory 130, or from elsewhere in a network. In addition, a user 80 may manually identify herself in the domain 30 using the user interface 150, for example, and the controller 100 can then obtain her preferences from local memory 130 or from elsewhere. Furthermore, the controller 110 can identify a user 80 based on identification of an active device 50 and can access the user's preferences from local memory 130 or from elsewhere.

When two or more users 80 are active in the domain 30, the preference handler 112 determines whether the preferences of these users 80 are relevant to the current context of the domain 30 and uses one or more preference arbitration schemes 134 to handle any conflicts in the preferences. The preference arbitration schemes 134 can use various algorithms for negotiating or arbitrating conflicting preference. As provided in more detail below, the schemes 134 can use ownership, rankings, averaging, weighting, priorities, order of entering the domain, and history of preferred selection for a set of devices. Some example scenarios are discussed below to show how the device handler 112 uses the preference arbitration schemes 134 for a set of circumstances.

In a first example scenario, a first user 81 has a non-compromiseable preference for operating one of the systems 140 in the vehicle 31, while other users 82 and 83 have either compromiseable or yielding preferences. In this situation, the non-compromiseable preference of the first user 81 essentially vetoes the preferences of the other users 82 and 83. This may be the case where the first user 81 is the driver, the vehicle owner, or is a user that otherwise owns the domain 30. In a second example scenario, the first user 81 has a compromiseable preference for operating one of the systems 140, and the other users 82 and 83 have preferences in the yielding category. In this situation, the compromiseable preference for the first user 81 is used during operation of the system 140. This may be the case where the other users 82 and 83 are guests in the domain 30, and any preferences associated with them are automatically set to the yielding category.

In a third example scenario, at least two of the users 81, 82, and 83 have compromiseable preferences. In this situation, the compromiseable preferences are negotiated according to a preference arbitration scheme 134. In general, the preference arbitration scheme 134 negotiates the preferences by determining a level, attribute, or selection of a preference to operate the system 140 based on ranges, weightings, or rankings associated with preferences of the users 80.

In a fourth example scenario, at least two of the users 80 each have non-compromiseable preferences for operating one of the systems 140. In this situation, the non-compromiseable preferences are negotiated according to a preference arbitration scheme 134. In general, the preference arbitration scheme 134 selects the preference of the owner of the domain 30 if available. If no owner is present, the preference arbitration scheme 134 determines a level, attribute, or selection of a preference that is common to all of the users 80. If no common selection can be made, the preference arbitration scheme 134 selects the preference for the highest ranked user 80 currently in the domain 30 or the preference associated with the first of the users 80 to enter the domain 30.

With this general understanding of the operation of the preferences handler 112, several examples of arbitrating preferences for multiple users 80 interacting with the controller 100 is discussed. In a first example of arbitrating preferences, the users 80 have preferences associated with them for controlling audio in the vehicle domain 30. The first user 81 may be the driver, and the second and third users 82 and 83 may be passengers. Accordingly, these users 80 may have different and potentially conflicting preferences with respect to audio settings, and the preferences can affect how audio should be delivered or controlled in the vehicle 30 with the entertainment system 160.

For example, the satellite radio of the entertainment system 160 can have predefined radio stations pertaining to certain types or genres of music available from a satellite radio provider. One of the users 80 makes a request to operate the satellite radio of the entertainment system 160, but the users 80 have preferences for different genres of music. The device handler 112 uses an arbitration scheme 134 to determine from the preferences stored in the profiles 132 what genre to use for a station of the satellite radio so that the selected station satisfies the preferred genres of the users 80 in the vehicle domain 30.

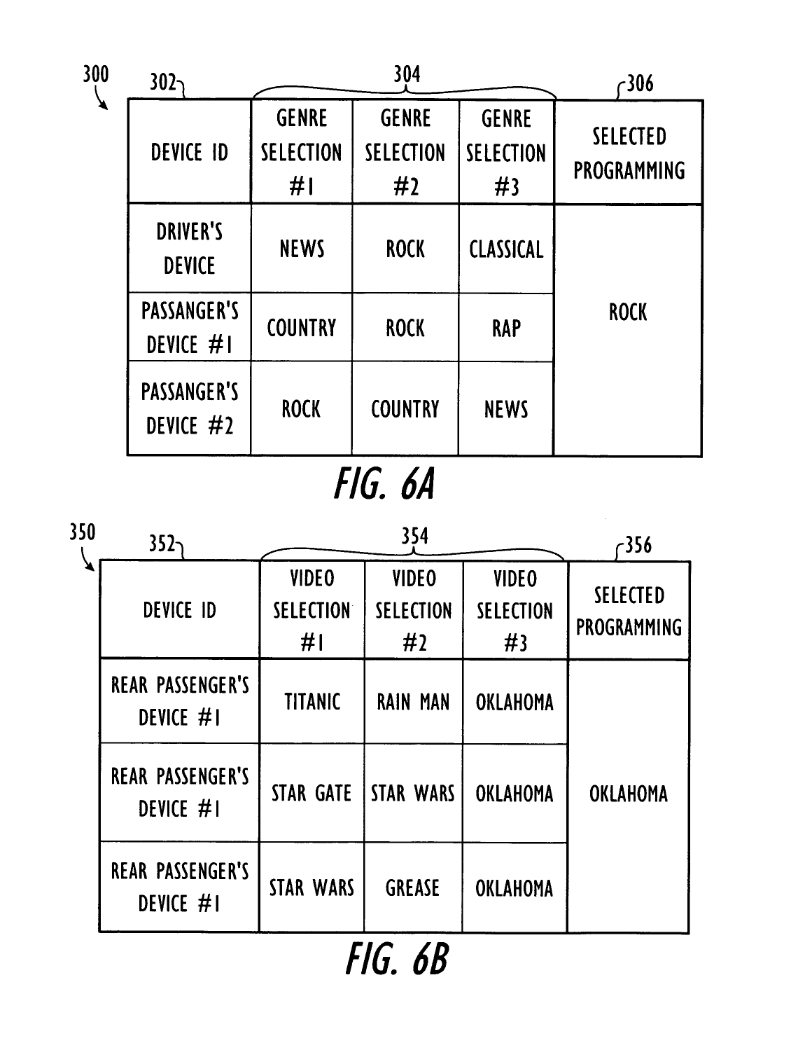

One way of arbitrating preferences is to establish a ranking, weighting, or priority of preferences so that the preference handler 112 can resolve conflicts between preferences. In FIG. 6A, for example, preferences for users are ranked in an order within a preference arbitration scheme 300, which is shown in tabular form. The scheme 300 includes device IDs 302 and ranked genre selections 304 for active devices in the domain. These genre selections 304 can be relevant to the operation of a satellite radio of an entertainment system in a vehicle and can be used to set which station to operate the radio. The device IDs 302 in this example correspond to users having detected devices of in the domain and are listed as “Driver's Device,” “Front Passenger's Device,” etc. for illustrative purposes. Each user has a plurality of genre selections 304 that are ranked in order.

Based on a comparison of the genre selections 304 and their rankings, the preference handler determines which genre satisfies the preferences of the all the users 302. In this case, the arbitration scheme 300 shows that “Rock” is the preferred genre 306. Based on the determination from the preference arbitration scheme 300, the preference handler 112 of FIG. 5 sets or suggests that the satellite radio of the entertainment system 160 be operated with a station having the “Rock” genre. Thus, the preference handler 112 can initially set the satellite radio to a station having the “Rock” genre but may allow the station to be changed.

In a second example of arbitrating preferences, the users 80 of FIG. 5 have different and potentially conflicting preferences with respect to video, and the preferences can influence how video should be delivered or controlled in the vehicle 31 with a video display of the entertainment system 160. During operation, one of the users 80 makes a request to play a movie on the video display of the entertainment system 160. Each of the users 80 has different preferred video selections associated with them. The preference handler 112 determines from those preferences 132 which video content to deliver with the video display of the entertainment system 160 according to a preference arbitration scheme 134.

For example, FIG. 6B shows an example of an arbitration scheme 350 where video selections 354 are ranked for each user 352 identified in the domain or having an active device in the domain. These ranked video selections 354 are relevant to the operation of the video display of the entertainment system in the vehicle and can be used to determine which video to deliver with the video display. Based on a comparison of the preferred video selections 354 and their rankings, the arbitration scheme 350 shows that “Oklahoma” is the preferred video selection for all three users 352.

After determining the preferred video selection, the preference handler 112 of FIG. 5 plays or suggests playing the selected video on the video display of the entertainment system 160. For example, in response to a request in the vehicle 31 to play a video, the preference handler 112 sets the selected video as an initial option to be selected by the users 80 for playing on the video display of the entertainment system 160.

In a third example of arbitrating preferences, the users 80 have different preferences for the temperature of the vehicle cabin. In this situation, the device handler 112 has a plurality of preferred cabin temperatures or ranges to arbitrate when a request to operate the vehicle's environmental system 170 is made. Using a preference arbitration scheme 134, the device handler 112 determines a cabin temperature or range that suits the preferences of each user 80 in the vehicle domain 30.

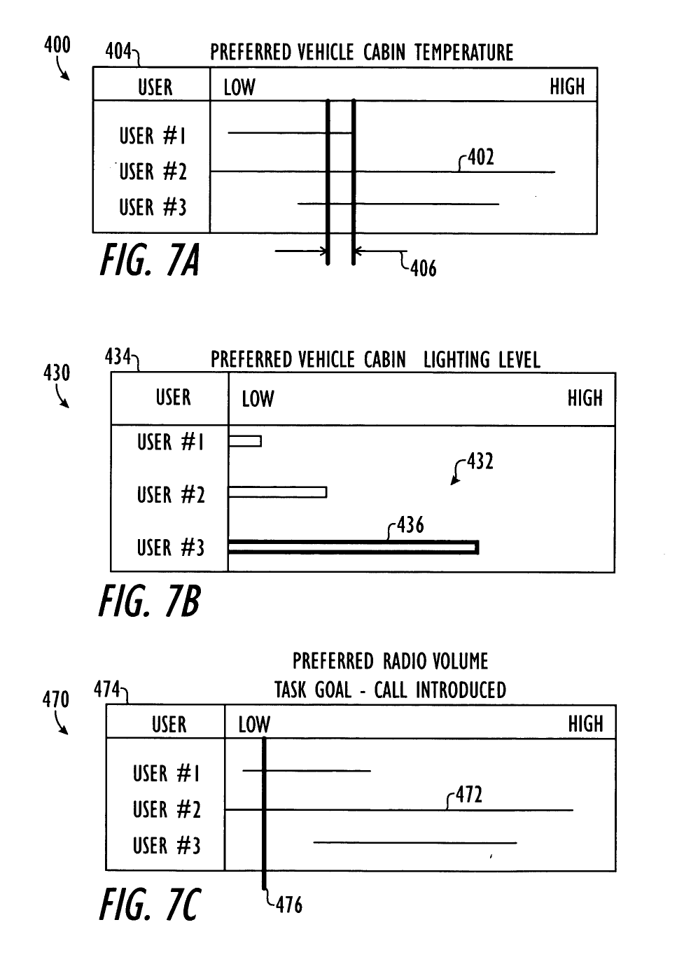

One way of arbitrating preferred ranges or values involves mathematically averaging them. In FIG. 7A, for example, an arbitration scheme 400 is shown in graphical form for arbitrating a preferred cabin temperature or range for a vehicle. The preferred temperature ranges 402 of three users 404 associated with the active devices in the vehicle are shown. A comparison of the preferred temperature ranges is made to determine a suitable range or value 406 for the vehicle cabin that accommodates the preferences of each user 404. In this example, the suitable range 406 is an interval in the temperature ranges that overlap in all three preferred ranges 402. Based on the determination from the preference arbitration scheme, the preference handler 112 of FIG. 5 then controls operation of the vehicle's environmental system 170 according to that determined range 406 of FIG. 7A.

In a fourth example of arbitrating preferences, the users 80 of FIG. 5 have different preferences for the cabin lighting level in the vehicle 31. In FIG. 7B, a preference arbitration scheme 430 is shown in graphical form for arbitrating a preferred cabin lighting level for a vehicle. The preferred lighting levels 432 of three users 434 associated with the active devices in the vehicle are shown. Rather than negotiating between the preferred lighting levels 432, the characteristic of each user 434 associated with the preferred lighting levels 432 is determined. For example, the device associated with the owner of the vehicle may be detected, or one of the users may be defined as the owner of the vehicle domain. Based on this determination, a preferred lighting level 436 of this owner (i.e., User #3) is selected over the other preferred lighting levels 432. As a result, the preference handler 112 of FIG. 5 can then control operation of the lighting levels of the environmental system 170 in vehicle 31 according to that preferred level.

In a fifth example of arbitrating preferences, the users 80 of FIG. 5 have different preferences for audio levels in the vehicle 31. In contrast to previous examples, these preferred audio levels have a controlling task or other criteria that controls or restricts them. In FIG. 7C, for example, an arbitration scheme 470 is shown in graphical form for arbitrating preferences based on a task goal. In this example, each user 474 has a preferred range 472 for audio volume to operate the entertainment system in the vehicle. The arbitration scheme 470, however, is restricted by a task goal, which in this example pertains to a call being introduced in the vehicle. Thus, an arbitrated or predefined level 476 is automatically selected when a call is introduced in the vehicle. As a result, the preference handler 112 of FIG. 5 can then control operation of the audio levels of the entertainment system 160 in vehicle 31 according to that preferred level. Another possible controlling task includes automatically switching between visual and audio navigation directions when the vehicle is in drive or when a call is introduced in the vehicle.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A preference-handling method, comprising:
storing preferences accessible to a controller;
determining preferences associated with at least two users active in a domain of the controller, each of the preferences being related to operation of a domain system operably coupleable to the controller;
arbitrating determined preferences based on an arbitration scheme of the controller; and
controlling operation of the domain system based on the arbitration of the preferences.

2. The method of claim 1, wherein storing preferences comprises one or more of:
storing preferences on a device communicatively coupleable to the controller;
storing preferences at a remote storage accessible to the controller via a network; and
storing preferences at the controller.

3. The method of claim 1, wherein the domain of the controller comprises a home domain, a vehicle domain, a work domain, a portable domain, or a public domain.

4. The method of claim 1, where the domain system operably coupleable to the controller comprises a networked computer system, a user interface system, an entertainment system, a navigation system, a communication system, or an environmental system.

5. The method of claim 1, wherein determining preferences comprises:
monitoring for devices active in the domain of the controller; and
obtaining preferences associated with users of the active devices.

6. The method of claim 1, wherein the preferences comprise a list of types, a range of values, a weighting, a priority, a ranking, a controlling task, a rule, or a restriction, and wherein arbitrating the preferences comprises one or more of:
selecting a type in all or most of the lists;
selecting a preference having a highest priority;
selecting a value within ranges of each of the preferences;
selecting a preference having a greatest weighting;
selecting a preference based on a task controlling the domain;
selecting a preference based on a safety rule relevant to a domain, a user, or a system; and
selecting a preference based on a health restriction relevant to a domain, a user, or a system.

7. The method of claim 1, wherein the preferences are defined as non-compromiseable, and wherein arbitrating determined preferences comprises selecting a preference associated with the user having a highest rank.

8. The method of claim 1, wherein the preferences are defined as non-compromiseable, and wherein arbitrating determined preferences comprises:
determining whether an automatic selection of a preference has resulted from the arbitration scheme; and
receiving a manual selection of a preference if the automatic selection has not resulted.

9. The method of claim 1, wherein the preferences are defined as compromiseable or yielding, and wherein arbitrating determined preferences comprises negotiating a preference satisfying each of the compromiseable preferences.

10. The method of claim 1, wherein one of the preferences associated with one of the users is defined as non-compromiseable, wherein the other preferences are defined as compromiseable or yielding, and wherein arbitrating the preferences comprises selecting the non-compromiseable preference.

11. The method of claim 1, wherein controlling operation of the system comprises one or more of:
operating an entertainment system with a selected attribute for a user interface of the system;
delivering a selected type of entertainment with an entertainment system;
delivering a selected entertainment file with an entertainment system;
delivering entertainment with an entertainment system according to a selected audible or visual preference;
operating an environmental system with a selected temperature level or range, with a selected lighting level, or with selected attribute for a user interface of the system;
operating a communication system with a selected audible or visual preference;
enabling a communication system to use an entertainment system to deliver communications in the domain; and
operating a user interface with a selected attribute for user interaction.

12. A preference-handling system, comprising:
one or more interfaces for communicatively connecting with devices;
memory for storing preferences for users; and
a controller operably coupleable to the one or more interfaces and the memory, the controller configured to:
determine preferences associated with at least two users active in a domain of the preference-handling system, each of the preferences being related to operation of a domain system operably coupleable to the controller;
arbitrate determined preferences based on an arbitration scheme of the controller; and
control operation of the domain system based on the arbitration of the preferences.

13. The system of claim 12, wherein the memory for storing preferences for users comprises one or more of:
memory on a portable device communicatively coupleable to the controller;
memory remotely accessible to the controller via a network; and
memory stored locally at the controller.

14. The system of claim 12, wherein the domain comprises a home domain, a vehicle domain, a work domain, a portable domain, or a public domain.

15. The system of claim 12, where the domain system comprises a networked computer system, a user interface system, an entertainment system, a navigation system, a communication system, or an environmental system.

16. The system of claim 12, wherein to determine preferences, the controller is configured to:
monitor for devices active in domain of the controller; and
obtain preferences associated with users of the active devices.

17. The system of claim 12, wherein the preferences comprise a list of types, a range of values, a weighting, a priority, a ranking, a controlling task, a rule, or restriction, and wherein to arbitrate determined preferences, the controller is configured to select one or more of: a type in all or most of the lists; a preference having a highest priority; a value within ranges of each of the preferences; a preference having a greatest weighting; a preference based on a task controlling the domain; and a preference based on a safety rule relevant to a domain, a user, or a system; and a preference based on a health restriction relevant to a domain, a user, or a system.

18. The system of claim 12, wherein the preferences are defined as non-compromiseable, and wherein to arbitrate determined preferences, the controller is configured to select a preference associated with the user having a highest rank.

19. The system of claim 12, wherein the preferences are defined as non-compromiseable, and wherein to arbitrate determined preferences, the controller is configured to:
determine whether an automatic selection of a preference has resulted from the arbitration scheme; and
receive a manual selection of a preference if the automatic selection has not resulted.

20. The system of claim 12, wherein to control operation of the system, the controller is configured to perform one or more of:
operate an entertainment system with a selected attribute for a user interface of the system;
deliver a selected type of entertainment with an entertainment system;
deliver a selected entertainment file with an entertainment system;
deliver entertainment with an entertainment system according to a selected audible or visual preference;
operate an environmental system with a selected temperature level or range, with a selected lighting level, or with selected attribute for a user interface of the system;
operate a communication system with a selected audible or visual preference;
enable a communication system to use an entertainment system to deliver communications in the domain; and
operate a user interface with a selected attribute for user interaction.
